(19) United States
(12) Patent Application Publication
(10) Pub. No.: US 2017/0247522 A1
(43) Pub. Date: Aug. 31, 2017

(54) Propylene-Based Elastomers and Propylene Polymers Useful for Foam Applications

(71) Applicant: ExxonMobil Chemical Patents Inc., Baytown, TX (US)

(72) Inventors: Jan Kalfus, Spring, TX (US); Abdul M. Jangda, Humble, TX (US); Liang Li, Shanghai (CN); Felix M. Zacarias, Houston, TX (US)

(21) Appl. No.: 15/395,587

(22) Filed: Dec. 30, 2016

Related U.S. Application Data
(60) Provisional application No. 62/300,570, filed on Feb. 26, 2016.

(51) Int. Cl. C08J 9/10

(52) U.S. Cl. CPC C08J 9/103; C08J 2203/04; C08J 2323/12; C08J 2323/16; C08J 2423/12; C08J 2423/16

(57) ABSTRACT

Provided herein are compositions including a blend of a propylene-based elastomer, a propylene polymer, and a foaming agent.

This invention claims priority to and the benefit of U.S. Patent Application Ser. No. 62/300,570, filed Feb. 26, 2016, which is herein incorporated by reference.

### FIELD OF THE INVENTION

Described herein are formulations comprising blends of propylene-based elastomers and propylene polymers which are useful in foam applications.

### BACKGROUND OF THE INVENTION

Compositions and membranes comprising thermoplastic olefin (TPO) polymers have found widespread use in the roofing industry for commercial buildings. Conventional roofing compositions include TPO polymers, such as Hifax CA 10A, that have good low elastic modulus at low temperatures. However, such TPO polymers are costly and do not have high elastic modulus at high temperatures.

For roofing and other sheeting applications, the products are typically manufactured as membrane sheets having a typical width of 10 feet (3 meters) or greater, although smaller widths may be available. The sheets are typically sold, transported, and stored in rolls. For roofing membrane applications, several sheets are unrolled at the installation site, placed adjacent to each other with an overlapping edge to cover the roof and are sealed together by a heat welding process during installation. During transport and storage, the rolls can be exposed to extreme heat conditions, such as from 30° C. to 100° C., which can lead to roll blocking of the rolls during storage in a warehouse. After installation, the membranes can be exposed during service to a wide range of conditions that may deteriorate or destroy the integrity of the membrane. As such, a membrane is desired that can withstand a wide variety of service temperatures, such as from −30° C. to 30° C. In addition, roofing membranes are sought that have very low permeability to vapors, for example when used to insulate building structures from rain water.

PCT Publication No. WO 2010/115079A1 is directed to roofing membranes that contain compositions of Formula I that comprise (a) 30 to 50 wt % of a propylene-based elastomer, (b) 9 to 20 wt % of a plastomer, (c) from 7 to 20 wt % of an impact polypropylene-ethylene copolymer, (d) 20 to 35 wt % of magnesium hydroxide, (e) 5 to 10 wt % of titanium dioxide, and (f) 1 to 2 wt % of additives; or compositions of Formula II that comprise (a) 32 to 48 wt % of a propylene-based elastomer, (b) 9 to 18 wt % of a plastomer, (c) 7 to 20 wt % of an impact polypropylene-ethylene copolymer, (d) 25 to 35 wt % of magnesium hydroxide, (e) 4 to 6 wt % of titanium dioxide, (f) 0.75 to 1.5 wt % of UV inhibitor, (g) 0.2 to 0.45 wt % of antioxidant/stabilizer, (h) 0.15 to 0.4 wt % of thermal stabilizer, and (i) 0.1 to 0.2 wt % of lubricant. The propylene-based elastomer used in WO 2010/115079A1 was Vistamaxx™ 6102 and the lubricant used was Asahi AX71 which is a mono or di-stearyl acid phosphate. The roofing membrane in WO 2010/115079A1 is formed around a scrim having reinforcing polyester threads.

PCT Publication No. WO 2014/001224A1 is directed to compositions comprising 40 to 75 wt % of at least one polypropylene-based elastomer and around 25 to 60 wt % of at least one random copolymer of polypropylene. The polypropylene-based elastomers used in WO 2014/001224A1 were Vistamaxx™ 3980, 6102, and 6202.

PCT Publication No. WO 2014/040914A1 is directed to thermoplastic mixtures that comprise at least one impact-resistant polypropylene copolymer and at least one ethylene-1-octene copolymer, where the weight ratio of impact-resistant polypropylene copolymer to ethylene-1-octene copolymer is in the range of 35:65 to 65:35.

PCT Publication No. WO2016/137558A1 is directed to a roofing membrane composition of a 10-50 wt % of a propylene-based elastomer, 5-40 wt % of a thermoplastic resin, at least one flame retardant, and at least one ultraviolet stabilizer.

U.S. application Ser. No. 15/259,750 is directed to a reactor blend composition for a roofing application of 70-95 wt % of a propylene-based elastomer and 5-30 wt % of an ethylene copolymer.

There still remains a need for roofing membranes that demonstrate flexibility at service temperatures from −30° C. to 30° C. and resistance to roll blocking at elevated temperatures around 100° C. that are less costly than existing commercial foaming compositions.

### BRIEF DESCRIPTION OF THE FIGURES

FIG. 1 illustrates the storage modulus of Formulation A and Comparative Hifax CA10.

FIG. 2 illustrates the elongation behavior of Formulation A and Comparative Hifax CA10.

FIG. 3 illustrates a SEM image of cryo-faced foamed Formulation A.

### SUMMARY OF THE INVENTION

Provided herein is a composition comprising from about 25 wt % to about 60 wt % of a propylene-based elastomer based on the foam composition, wherein the propylene-based polymer elastomer has an ethylene content of about 15 wt % to about 30 wt % based upon the weight of the propylene-based elastomer; a propylene polymer, comprising a homopolymer of propylene or a copolymer of propylene with from about 0.5 to about 4 wt % ethylene or C₄ to C₁₀ alpha-olefin comonomer derived units; and from about 0.5 to about 5 wt % of a foaming agent based on the foam composition, wherein the ratio of the propylene-based elastomer to the propylene polymer is about 40% to about 60%.

### DETAILED DESCRIPTION OF THE INVENTION

Various specific embodiments and versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the embodiments defined by the claims. The use of headings is for purposes of convenience only and does not limit the scope of the present invention.

Described herein are compositions comprising propylene-based elastomers and propylene polymers that are suitable for foaming applications, particularly roofing membranes. The compositions provide a balance of properties over a wide range of temperatures. For example, the compositions exhibit flexibility at temperatures from −30° C. to 30° C. and improved properties at elevated temperatures.

All numerical values within the detailed description and the claims herein are modified by “about” or “approximately” the indicated value, and take into account experimental error and variations that would be expected by a person having ordinary skill in the art.

As used herein, the term “copolymer” is meant to include polymers having two or more monomers, optionally, with other monomers, and may refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic and atactic symmetries. The term “blend” as used herein refers to a mixture of two or more polymers. The term “elastomer” shall mean any polymer exhibiting some degree of elasticity, where elasticity is the ability of a material that has been deformed by a force (such as by stretching) to return at least partially to its original dimensions once the force has been removed.

The term “monomer” or “comonomer,” as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”. Different monomers are discussed herein, including propylene monomers, ethylene monomers, and diene monomers.

“Reactor grade,” as used herein, means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

### Propylene-Based Elastomer

The polymer blend described herein comprises one or more propylene-based elastomers (“PBEs”). The PBE comprises propylene and from about 5 to about 30 wt % of one or more comonomers selected from ethylene and/or C₄-C₁₂ α-olefins, and, optionally, one or more dienes. For example, the comonomer units may be derived from ethylene, butene, pentene, hexene, 4-methyl-1-pentene, octene, or decene. In preferred embodiments, the comonomer is ethylene. In some embodiments, the propylene-based elastomer composition consists essentially of propylene and ethylene derived units, or consists only of propylene and ethylene derived units. Some of the embodiments described below are discussed with reference to ethylene as the comonomer, but the embodiments are equally applicable to other copolymers with other higher α-olefin comonomers. In this regard, the copolymers may simply be referred to as PBEs with reference to ethylene as the α-olefin.

The PBE may include at least about 5 wt %, at least about 7 wt %, at least about 9 wt %, at least about 10 wt %, at least about 12 wt %, at least about 13 wt %, at least about 14 wt %, at least about 15 wt %, or at least about 16 wt %, α-olefin-derived units, based upon the total weight of the PBE. The PBE may include up to about 30 wt %, up to about 25 wt %, up to about 22 wt %, up to about 20 wt %, up to about 19 wt %, up to about 18 wt %, or up to about 17 wt %, α-olefin-derived units, based upon the total weight of the PBE. In some embodiments, the PBE may comprise from about 5 wt % to about 30 wt %, from about 6 wt % to about 25 wt %, from about 7 wt % to about 20 wt %, from about 10 wt % to about 19 wt %, from about 12 wt % to about 19 wt %, or from about 15 wt % to about 18 wt %, or form about 16 wt % to about 18 wt %, α-olefin-derived units, based upon the total weight of the PBE.

The PBE may include at least about 70 wt %, at least about 75 wt %, at least about 78 wt %, at least about 80 wt %, at least about 81 wt %, at least about 82 wt %, or at least 83 wt %, propylene-derived units, based upon the total weight of the PBE. The PBE may include up to about 95 wt %, up to about 93 wt %, up to about 91 wt %, up to about 90 wt %, up to about 88 wt %, or up to about 87 wt %, or up to about 86 wt %, or up to about 85 wt %, or up to about 84 wt %, propylene-derived units, based upon the total weight of the PBE.

The PBEs can be characterized by a melting point (Tm), which can be determined by differential scanning calorimetry (DSC). Using the DSC test method described herein, the melting point is the temperature recorded corresponding to the greatest heat absorption within the range of melting temperature of the sample, when the sample is continuously heated at a programmed rate. When a single melting peak is observed, that peak is deemed to be the “melting point.” When multiple peaks are observed (e.g., principle and secondary peaks), then the melting point is deemed to be the highest of those peaks. It is noted that due to the low-crystallinity of many PBEs, the melting point peak may be at a low temperature and be relatively flat, making it difficult to determine the precise peak location. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

The Tm of the PBE (as determined by DSC) may be less than about 120° C., less than about 115° C., less than about 110° C., less than about 105° C., less than about 100° C., less than about 90° C., less than about 80° C., less than about 70° C., less than about 65° C., or less than about 60° C. In some embodiments, the PBE may have a Tm of from about 20 to about 110° C., from about 30 to about 110° C., from about 40 to about 110° C., or from about 50 to about 105° C., where desirable ranges may include ranges from any lower limit to any upper limit. In some embodiments, the PBE may have a Tm of from about 40 to about 70° C., or from about 45 to about 65° C., or from about 50 to about 60° C., where desirable ranges may include ranges from any lower limit to any upper limit. In some embodiments, the PBE may have a Tm of from about 80 to about 110° C., or from about 85 to about 110° C., or from about 90 to about 105° C., where desirable ranges may include ranges from any lower limit to any upper limit.

The PBE can be characterized by its heat of fusion (Hf), as determined by DSC. The PBE may have an Hf that is at least about 0.5 J/g, at least about 1.0 J/g, at least about 1.5 J/g, at least about 3.0 J/g, at least about 5.0 J/g, at least about 7.0 J/g, at least about 10.0 J/g, or at least about 12 J/g. The PBE may be characterized by an Hf of less than about 75 J/g, less than about 65 J/g, at less than about 60 J/g, less than about 55 J/g, less than about 50 J/g, less than about 40 J/g, less than about 35 J/g, less than about 30 J/g, less than about 25 J/g, less than about 20 J/g, less than about 17 J/g, or less than 15 J/g. In some embodiments, the PBE may have a Hf of from about 1.0 to about 40 J/g, from about 3.0 to about 30 J/g, or from about 5.0 to about 20 J/g, where desirable ranges may include ranges from any lower limit to any upper limit. In some embodiments, the PBE may have a Hf of from about 1.0 to about 15 J/g or from about 3.0 to about 10 J/g, where desirable ranges may include ranges from any lower limit to any upper limit. In some embodiments, the PBE may have a Hf of from 5.0 to about 30 J/g, from about 7.0 to about 25 J/g, or from about 12 to about 20 J/g, where desirable ranges may include ranges from any lower limit to any upper limit.

As used herein, DSC procedures for determining Tm and Hf are as follows. The polymer is pressed at a temperature of from about 200° C. to about 230° C. in a heated press, and the resulting polymer sheet is annealed, under ambient conditions of about 23.5° C., in the air to cool. About 6 to 10 mg of the polymer sheet is removed with a punch die. This 6 to 10 mg sample is annealed at about 23.5° C. for about 80 to 100 hours. At the end of this period, the sample is placed in a DSC (Perkin Elmer Pyris One Thermal Analysis System) and cooled to about −30° C. to about −50° C. and held for 10 minutes at −50° C. The sample is then heated at 10° C./min to attain a final temperature of about 200° C. The sample is kept at 200° C. for 5 minutes (“first melt”). Then a second cool-heat cycle (“second melt”) is performed, where the sample is cooled to about −30° C. to about −50° C. and held for 10 minutes at that temperature, and then re-heated at 10° C./min to a final temperature of about 200° C. Events from both cycles (“first melt” and “second melt”) are recorded. The thermal output is recorded as the area under the melting peak of the sample, which typically occurs between about 0° C. and about 200° C. It is measured in Joules and is a measure of the Hf of the polymer. Reference to Tm and Hf herein to first melt.

Preferably, the PBE has crystalline regions interrupted by non-crystalline regions. The non-crystalline regions can result from regions of non-crystallizable propylene segments, the inclusion of comonomer units, or both. In one or more embodiments, the PBE has a propylene-derived crystallinity that is isotactic, syndiotactic, or a combination thereof. In a preferred embodiment, the PBE has isotactic sequences. The presence of isotactic sequences can be determined by NMR measurements showing two or more propylene derived units arranged isotactically. Such isotactic sequences can, in some cases, be interrupted by propylene units that are not isotactically arranged or by other monomers that otherwise disturb the crystallinity derived from the isotactic sequences. In addition to differences in tacticity, the PBE polymer can also have defect structures that are regio-specific.

The PBE can have a triad tacticity of three propylene units (mmm tacticity), as measured by 13C NMR, of 75% or greater, 80% or greater, 85% or greater, 90% or greater, 92% or greater, 95% or greater, or 97% or greater. In one or more embodiments, the triad tacticity may range from about 75 to about 99%, from about 80 to about 99%, from about 85 to about 99%, from about 90 to about 99%, from about 90 to about 97%, or from about 80 to about 97%. Triad tacticity is determined by the methods described in U.S. Pat. No. 7,232,871.

The PBE may have a tacticity index m/r ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 describes an atactic material. An isotactic material theoretically may have a ratio approaching infinity, and many by-product atactic polymers have sufficient isotactic content to result in ratios of greater than 50.

The PBE may have a percent crystallinity of from about 0.5% to about 40%, from about 1% to about 30%, or from about 5% to about 25%, determined according to DSC procedures, where desirable ranges may include ranges from any lower limit to any upper limit. Crystallinity may be determined by dividing the Hf of a sample by the Hf of a 100% crystalline polymer, which is assumed to be 189 J/g for isotactic polypropylene.

The comonomer content and sequence distribution of the polymers can be measured using ¹³C nuclear magnetic resonance (NMR) by methods well known to those skilled in the art. Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, Vol. 47, pp. 1128-1130. For a propylene ethylene copolymer containing greater than 75 wt % propylene, the comonomer content (ethylene content) of such a polymer can be measured as follows: A thin homogeneous film is pressed at a temperature of about 150° C. or greater, and mounted on a Perkin Elmer PE 1760 infrared spectrophotometer. A full spectrum of the sample from 600 cm-1 to 4000 cm-1 is recorded and the monomer weight percent of ethylene can be calculated according to the following equation: Ethylene wt %=82.585−111.987X+30.045X2, where X is the ratio of the peak height at 1155 cm-1 and peak height at either 722 cm-1 or 732 cm-1, whichever is higher. For propylene ethylene copolymers having 75 wt % or less propylene content, the comonomer (ethylene) content can be measured using the procedure described in Wheeler and Willis. Reference is made to U.S. Pat. No. 6,525,157 which contains more details on GPC measurements, the determination of ethylene content by NMR and the DSC measurements.

The PBE may have a density of from about 0.84 g/cm³ to about 0.92 g/cm³, from about 0.85 g/cm³ to about 0.90 g/cm³, or from about 0.85 g/cm³ to about 0.87 g/cm³ at room temperature, as measured per the ASTM D-1505 test method, where desirable ranges may include ranges from any lower limit to any upper limit.

The PBE can have a melt index (MI) (ASTM D-1238, 2.16 kg @ 190° C.), of less than or equal to about 10 g/10 min, less than or equal to about 8.0 g/10 min, less than or equal to about 5.0 g/10 min, or less than or equal to about 3.0 g/10 min, or less than or equal to about 2.0 g/10 min. In some embodiments, the PBE may have a MI of from about 0.5 to about 3.0 g/10 min, or from 0.75 to about 2.0 g/10 min, where desirable ranges may include ranges from any lower limit to any upper limit.

The PBE may have a melt flow rate (MFR), as measured according to ASTM D-1238 (2.16 kg weight @ 230° C.), greater than about 1.0 g/10 min, greater than about 1.5 g/10 min, greater than about 2.0 g/10 min, or greater than about 2.5 g/10 min. The PBE may have an MFR less than about 25 g/10 min, less than about 15 g/10 min, less than about 10 g/10 min, less than about 7 g/10 min, or less than about 5 g/10 min. In some embodiments, the PBE may have an MFR from about 0.5 to about 10 g/10 min, from about 1.0 to about 7 g/10 min, or from about 1.5 to about 5 g/10 min, where desirable ranges may include ranges from any lower limit to any upper limit.

The PBE may have a Shore D hardness (ASTM D2240) of less than about 50, less than about 45, less than about 40, less than about 35, or less than about 20.

The PBE may have a Shore A hardness (ASTM D2240) of less than about 100, less than about 95, less than about 90, less than about 85, less than about 80, less than about 75, or less than 70. In some embodiments, the PBE may have a Shore A hardness of from about 10 to about 100, from about 15 to about 90, from about 20 to about 80, or from about 30 to about 70, where desirable ranges may include ranges from any lower limit to any upper limit.

In some embodiments, the PBE is a propylene-ethylene copolymer that has at least four, or at least five, or at least six, or at least seven, or at least eight, or all nine of the following properties (i) from about 10 to about 25 wt %, or from about 12 to about 20 wt %, or from about 16 wt % to about 17 wt % ethylene-derived units, based on the weight of the PBE; (ii) a Tm of from 80 to about 110° C., or from about 85 to about 110° C., or from about 90 to about 105° C.; (iii) a Hf of less than about 75 J/g, or less than 50 J/g, or less than 30 J/g, or from about 1.0 to about 15 J/g or from about 3.0 to about 10 J/g; (iv) a MI of from about 0.5 to about 3.0 g/10 min or from about 0.75 to about 2.0 g/10 min; (v) a MFR of from about 0.5 to about 10 g/10 min, or from 0.75 to about 8 g/10 min, or from about 0.75 to about 5 g/10 (vi) a Mw of from about 175,000 to about 260,000 g/mol, or from about 190,000 to about 250,000 g/mol, or from about 200,000 to about 250,000 g/mol, or from about 210,000 to about 240,000 g/mol; (vii) a Mn of from about 90,000 to about 130,000 g/mol, or from about 95,000 to about 125,000 g/mol, or from about 100,000 to about 120,000 g/mol; (viii) a MWD of from about 1.0 to about 5, or from about 1.5 to about 4, or from about 1.8 to about 3; and/or (ix) a Shore D hardness of less than 30, or less than 25, or less than 20. In some embodiments, such a PBE is a reactor-blended PBE as described herein.

Optionally, the PBE may also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene may be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the propylene-based polymer comprises a diene, the diene may be present at from 0.05 wt % to about 6 wt %, from about 0.1 wt % to about 5.0 wt %, from about 0.25 wt % to about 3.0 wt %, or from about 0.5 wt % to about 1.5 wt %, diene-derived units, based upon the total weight of the PBE.

Optionally, the PBE may be grafted (i.e., “functionalized”) using one or more grafting monomers. As used herein, the term “grafting” denotes covalent bonding of the grafting monomer to a polymer chain of the propylene-based polymer. The grafting monomer can be or include at least one ethylenically unsaturated carboxylic acid or acid derivative, such as an acid anhydride, ester, salt, amide, imide, acrylates or the like. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride is a preferred grafting monomer. In embodiments wherein the graft monomer is maleic anhydride, the maleic anhydride concentration in the grafted polymer is preferably in the range of about 1 wt % to about 6 wt %, at least about 0.5 wt %, or at least about 1.5 wt %.

In preferred embodiments, the PBE is a reactor grade or reactor blended polymer, as defined above. That is, in preferred embodiments, the PBE is a reactor blend of a first polymer component and a second polymer component. Thus, the comonomer content of the PBE can be adjusted by adjusting the comonomer content of the first polymer component, adjusting the comonomer content of second polymer component, and/or adjusting the ratio of the first polymer component to the second polymer component present in the PBE.

In embodiments where the PBE is a reactor blended polymer, the α-olefin content of the first polymer component (“R₁”) may be greater than 5 wt %, greater than 7 wt %, greater than 10 wt %, greater than 12 wt %, greater than 15 wt %, or greater than 17 wt %, based upon the total weight of the first polymer component. The α-olefin content of the first polymer component may be less than 30 wt %, less than 27 wt %, less than 25 wt %, less than 22 wt %, less than 20 wt %, or less than 19 wt %, based upon the total weight of the first polymer component. In some embodiments, the α-olefin content of the first polymer component may range from 5 wt % to 30 wt %, from 7 wt % to 27 wt %, from 10 wt % to 25 wt %, from 12 wt % to 22 wt %, from 15 wt % to 20 wt %, or from 17 wt % to 19 wt %. Preferably, the first polymer component comprises propylene and ethylene derived units, or consists essentially of propylene and ethylene derived units.

In embodiments where the PBE is a reactor blended polymer, the α-olefin content of the second polymer component (“R₂”) may be greater than 1.0 wt %, greater than 1.5 wt %, greater than 2.0 wt %, greater than 2.5 wt %, greater than 2.75 wt %, or greater than 3.0 wt % α-olefin, based upon the total weight of the second polymer component. The α-olefin content of the second polymer component may be less than 10 wt %, less than 9 wt %, less than 8 wt %, less than 7 wt %, less than 6 wt %, or less than 5 wt %, based upon the total weight of the second polymer component. In some embodiments, the α-olefin content of the second polymer component may range from 1.0 wt % to 10 wt %, or from 1.5 wt % to 9 wt %, or from 2.0 wt % to 8 wt %, or from 2.5 wt % to 7 wt %, or from 2.75 wt % to 6 wt %, or from 3 wt % to 5 wt %. Preferably, the second polymer component comprises propylene and ethylene derived units, or consists essentially of propylene and ethylene derived units.

In embodiments where the PBE is a reactor blended polymer, the PBE may comprise from 1 to 25 wt % of the second polymer component, from 3 to 20 wt % of the second polymer component, from 5 to 18 wt % of the second polymer component, from 7 to 15 wt % of the second polymer component, or from 8 to 12 wt % of the second polymer component, based on the weight of the PBE, where desirable ranges may include ranges from any lower limit to any upper limit. The PBE may comprise from 75 to 99 wt % of the first polymer component, from 80 to 97 wt % of the first polymer component, from 85 to 93 wt % of the first polymer component, or from 82 to 92 wt % of the first polymer component, based on the weight of the PBE, where desirable ranges may include ranges from any lower limit to any upper limit.

The PBE is preferably prepared using homogeneous conditions, such as a continuous solution polymerization process. In some embodiments, the PBE is prepared in parallel solution polymerization reactors, such that the first reactor component is prepared in a first reactor and the second reactor component is prepared in a second reactor, and the reactor effluent from the first and second reactors are combined and blended to form a single reactor effluent from which the final PBE is separated. Exemplary methods for the preparation of PBEs may be found in U.S. Pat. Nos. 6,881,800; 7,803,876; 8,013,069; and 8,026,323 and PCT Publications WO 2011/087729; WO 2011/087730; and WO 2011/087731, incorporated herein by reference.

Suitable PBEs for use in the present invention are Vistamaxx™ polymers, commercially available from ExxonMobil Chemical Company. The invention is not limited to the use of Vistamaxx™ as the PBE.

### Propylene Polymer

The compositions described herein may include one or more propylene polymers. The “propylene polymer” may be any material that is not a “propylene-based elastomer” as described herein. The term “propylene polymer” as used herein broadly means any polymer that is considered a “propylene” by persons skilled in the art and includes homo, impact, and random copolymers of propylene. Preferably, the propylene used in the compositions described herein has a melting point above 110° C. and includes at least 90 wt % propylene-derived units. The propylene may also include isotactic, atactic or syndiotactic sequences, and preferably includes isotactic sequences. The propylene can either derive exclusively from propylene monomers (i.e., having only propylene-derived units) or comprises at least 90 wt %, or at least 93 wt %, or at least 95 wt %, or at least 97 wt %, or at least 98 wt %, or at least 99 wt % propylene-derived units with the remainder derived from olefins, such as ethylene, and/or C₄-C₁₀ α-olefins.

The propylene polymer may have a melting temperature of from at least 110° C., or at least 120° C., or at least 130° C., and may range from 110° C. to 170° C. or higher as measured by DSC.

The propylene polymer may have a melt flow rate “MFR” as measured by ASTM D1238 at 230° C. and 2.16 kg weight of from about 0.1 to 100 g/10 min. In some embodiments, the propylene polymer may have a fractional MFR, such a polypropylene having a fractional MFR of less than about 2 g/10 min, or less than about 1.5 g/10 min, or less than about 1 g/10 min. In some embodiments, the propylene polymer may have a MFR of from a low of about 25, 26, 27, 28, 29, 30, 31, 32, or 33 g/10 min to a high of about 37, 38, 39, 40, 41, 42, 43, 44, or 45 g/10 min, where desirable ranges may include ranges from any lower limit to any upper limit. In some embodiments, the propylene polymer may have a MFR of from a low of about 5, 10, or 15 g/10 min to a high of about 20, 25, or 30 g/10 min, where desirable ranges may include ranges from any lower limit to any upper limit.

Suitable propylene polymers for use in the present invention are polypropylene homopolymers, such as PP2155, commercially available from ExxonMobil Chemical Company. The invention is not limited to the use of PP3155 as the propylene polymer.

### Foaming Agent

The compositions described herein may also incorporate a variety of additives, including a foaming agent. The foaming agent is present in the amount of up to about 5 wt % of the composition, or up to about 2 wt %. In some embodiments, the foaming agent is present in the amount of at least 1 wt % of the composition. Preferably, the foaming agent is a azo-diazo compound.

Suitable foaming agent for use in the present invention is A96606 ALDRICH, 97% azodicarboxamide, commercially available from Sigma-Aldrich. The invention is not limited to the use of A96606 as the foaming agent.

### Foaming Compositions

The compositions described herein are particularly useful for foaming applications, such as for thermoplastic polyolefin roofing membranes. Membranes produced from the compositions may exhibit a beneficial combination of properties, and in particular exhibit an improved balance of flexibility at temperatures from −30° C. to 30° C. along with stability at elevated temperatures such as those from 30° C. to 100° C.

The foaming compositions described herein may be made either by pre-compounding or by in-situ compounding using polymer-manufacturing processes such as Banbury mixing or twin screw extrusion. The compositions may then be formed into roofing membranes. The roofing membranes may be particularly useful in commercial roofing applications, such as on flat, low-sloped, or steep-sloped substrates.

The roofing membranes may be fixed over the base roofing by any means known in the art such as via adhesive material, ballasted material, spot bonding, or mechanical spot fastening. For example, the membranes may be installed using mechanical fasteners and plates placed along the edge sheet and fastened through the membrane and into the roof decking. Adjoining sheets of the flexible membranes are overlapped, covering the fasteners and plates, and preferably joined together, for example with a hot air weld. The membrane may also be fully adhered or self-adhered to an insulation or deck material using an adhesive. Insulation is typically secured to the deck with mechanical fasteners and the flexible membrane is adhered to the insulation.

The roofing membranes may be reinforced with any type of scrim including, but not limited to, polyester, fiberglass, fiberglass reinforced polyester, polypropylene, woven or non-woven fabrics (e.g., Nylon) or combinations thereof. Preferred scrims are fiberglass and/or polyester.

In some embodiments, a surface layer of the top and/or bottom of the membrane may be textured with various patterns. Texture increases the surface area of the membrane, reduces glare and makes the membrane surface less slippery. Examples of texture designs include, but are not limited to, a polyhedron with a polygonal base and triangular faces meeting in a common vertex, such as a pyramidal base; a cone configuration having a circular or ellipsoidal configurations; and random pattern configurations.

The compositions described herein comprise a blend composition of a propylene-based elastomer, propylene polymer, and a foaming agent.

The blend compositions may comprise from about 25 to about 60 wt % of the propylene-based elastomer. For example, the blend composition may comprise at least 25 wt %, or at least 30 wt %, or at least 35 wt % of the propylene-based elastomer. In some embodiments, the blend composition comprises less than 60 wt % or less than 55 wt % of the propylene-based elastomer.

The propylene-based elastomer may be any of those described herein. However, in some preferred embodiments, the propylene-based elastomer may have an ethylene content of from 5 to 30 wt %, based upon the weight of the propylene-based elastomer, wherein the propylene-based elastomer is a reactor blend of a first polymer component and a second polymer component, wherein the first polymer component has an ethylene content R₁ of from greater than 5 to less than 30 wt % α-olefin, based upon the total weight of the first polymer component, and wherein the second polymer component has an ethylene content R₂ of from greater than 1 to less than 10 wt % α-olefin, based upon the total weight of the second polymer component. In some preferred embodiments, the propylene-based elastomer has an ethylene content of from 16 to 18 wt %, a melting temperature of less than 120° C., and a heat of fusion of less than 75 J/g.

### Examples

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

The test methods used in the Examples are described below.

Dynamic Mechanical Thermal Analysis (“DMTA”) tests were conducted on samples made in the Examples to provide information about the small-strain mechanical response of the sample as a function of temperature. Sample specimens were tested using a commercially available DMA instrument (e.g., TA Instruments DMA 2980 or Rheometrics RSA) equipped with a dual cantilever test fixture. The specimen was cooled to −80° C. and then heated to 120° C. at a rate of 2° C./min while being subjected to an oscillatory deformation at 0.1% strain and a frequency of 1 Hz. The output of the DMTA test is the storage modulus (E′) and the loss modulus (E″). The storage modulus indicates the elastic response or the ability of the material to store energy, and the loss modulus indicates the viscous response or the ability of the material to dissipate energy. Glass transition temperature (Tg) is defined to be the temperature associated with the peak loss modulus (E″).

Tensile tests were conducted according to ASTM D638 Type IV method with a velocity of 10 mm/min.

Density tests were conducted with a glass pycknometer with water as a medium.

Water absorption tests were conducted according to ASTM D1056 method.

In the Examples, “PP3155” was ExxonMobil™ PP 3155 polypropylene available from ExxonMobil Chemical Company. PP3155 is a polypropylene homopolymer with a density of 0.9 g/cc and a melt mass-flow rate (MFR) (230° C.; 2.16 kg) of 36 g/10 min (ASTM D1238).

In the Examples, “Vistamaxx™6102” was Vistamaxx™6102 propylene-based elastomer available from ExxonMobil Chemical Company. Vistamaxx™6102 is a propylene-ethylene copolymer containing 16 wt % ethylene-derived units and has the following typical properties: a density of 0.862 g/cc (ASTM D1505), a melt index (190° C.; 2.16 kg) of 1.4 g/10 min (ASTM D1238), a melt mass-flow rate (MFR) (230° C.; 2.16 kg) of 3 g/10 min (ASTM D1238), a Shore A durometer hardness of 66 (ASTM D224), and a Vicat softening temperature of 52.2° C.

Hifax™ CA10A is a reactor thermoplastic polyolefin available from Lyondell/Basell Industries. Hifax™ CA10A has a density of 0.88 g/cc, a melt flow rate (230° C.; 2.16 kg) of 0.6 g/10 min, a Vicat softening temperature of 60° C., a melting temperature of 142° C., and a Shore D hardness of 30. Hifax™ CA10A is also referred to in the figures of this invention as Comparative Hifax CA10A.

The Foaming Agent used in the examples is A96606 ALDRICH available from Sigma-Aldrich. A96606 is 97% azodicarboxamide.

49.5 wt % PP3155, 49.5 wt % Vistamaxx™6102, and 1 wt % A96606 (reported in the figures as Formulation A) were melt extruded on a 11 mm twin screw extruder Thermo Prism. All zones of the extruder were maintained at about 200° C. and operated at a rate of 250 rpm. Specimens for mechanical testing were made by compression molding 1 mm thick films at 200° C. for 2 minutes.

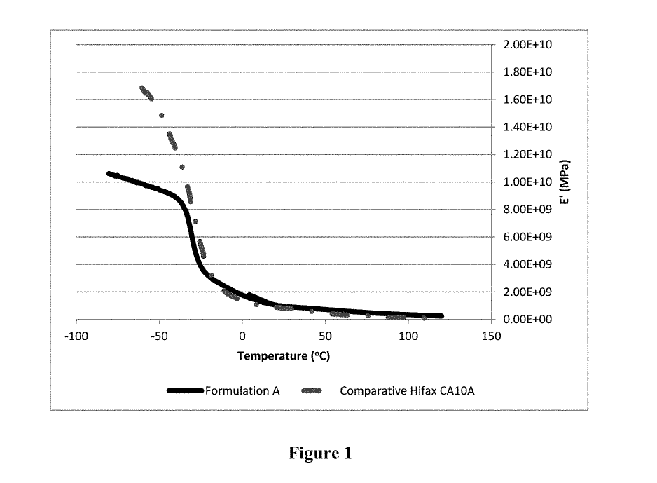

FIG. 1 shows a plot of Elastic modulus, E′ with temperature. Inventive Formulation A is softer (lower modulus) at temperatures below −50° C. as compared to Comparative Hifax CA10A. From −50° C. to 50° C., both Inventive Formulation A and the Comparative exhibit similar modulus. At temperatures above 50° C., the Inventive Formulation A is slightly stiffer (higher modulus) as compared to Comparative Hifax CA10A. The combination of low modulus at low temperatures, similar modulus at room temperatures, and higher modulus at elevated temperature of Inventive Formulation A versus Comparative Hifax CA10A show it to be a cost competitive alternative to existing foaming compositions.

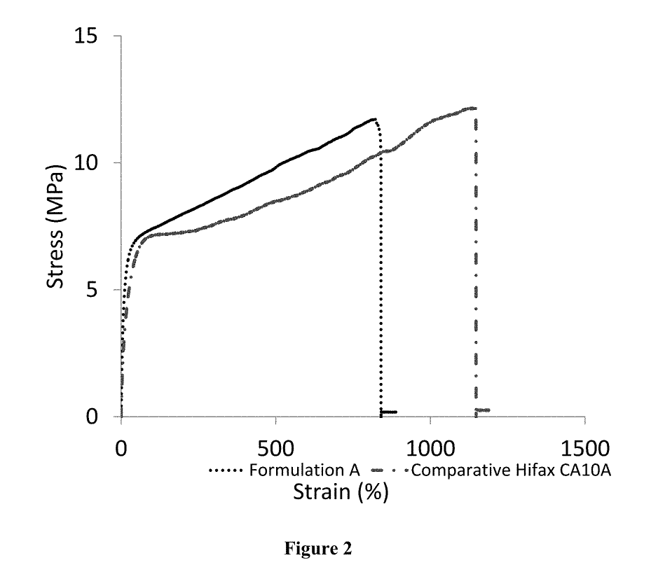

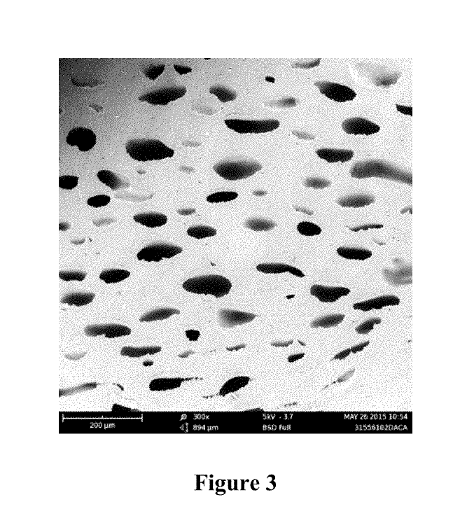

FIG. 2 shows a plot of Stress over Strain. Inventive Formulation A has an Elongation at Break of about 800%, whereas Comparative Hifax CA10A has an Elongation at Break of about 1150%. For roofing applications, an Elongation at Break over 500% indicates the material is hard to break and suitable for use in a membrane. Accordingly, FIG. 2 shows tensile properties of Inventive Formulation a are not compromised, as compared to Comparative Hifax CA10A. Inventive Formulation A, having a foaming agent, has voids (as illustrated in FIG. 3). It is generally known that voids do not carry any load and effectively decreases the cross-sectional area of composition, thereby lowering the tensile strength.

FIG. 3 is a scanning electron microscope (SEM) image of cryo-faced Inventive Formulation A, to show the composition morphology. Roofing membranes are selected to be vapor impermeable, such as to entrap water from entering a building structure. The presence of a closed cell morphology, as illustrated in FIG. 3, enables this water entrapment. Density of Inventive Formulation A was measured to be 0.69 g/cm³ and the water absorption, according to ASTM D570, was about 0.83%, confirming closed cell foam morphology. The presence of voids in Formulation A represents the additional softening mechanism that allows the foamed blend to have comparable modulus to Comparative Hifax CA10A, as indicated in FIG. 1.

To evaluate the tensile properties of the inventive composition, samples of PP3155 and Vistamaxx™6102 were combined with other additives as listed below in Table 1 (Ecocell® is a foaming agent, commercially available from Polyfill Additives Technology; the Flame Retardant Concentrate is a masterbatch concentrate of LLDPE and 80% calcium carbonate; the UV Stabilizer Concentrate is a masterbatch containing UV stabilizing additives, titanium-dioxide as the white pigment, and a carrier resin). All ingredients were dry blended. The formulations were extruded by a HAAKE single screw extruder equipped with a tape die. The tape was taken by a conveyor belt to allow for foaming. No calendering was applied. Tensile properties, measured by ASTM D638, Type IV, are also reported in Table 1.

TABLE 1

| | Sample 1 (Comparative) | Sample 2 (Inventive) |
|---|---|---|
| | 56 wt % Hifax CA10A | 28 wt % Vistamaxx 6102 |
| | 28 wt % Flame Retardant | 28 wt % PP3155 |
| | Concentrate | 28 wt % Flame Retardant |
| | 16 wt % UV Stabilizer | Concentrate |
| | Concentrate | 16 wt % UV Stabilizer |
| | | Concentrate |
| | | 1 wt % Ecocell |
| Specific Gravity | 1.096 | 0.962 |

Tensile Properties

| | | |
|---|---|---|
| Young's Modulus | 429 | 482 |
| (MPa) | | |
| Tensile Stress at | 15.4 | 12.1 |
| Break (MPa) | | |
| Nominal Strain at | 662 | 371 |
| Break (%) | | |

The specific gravity and tensile properties of Sample 1 (Comparative) and Sample 2 (Inventive) of Table 1 indicates that Sample 2 has similar properties as the comparative.

Certain embodiments and features have been described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

As used herein, the phrases “substantially no,” and “substantially free of” are intended to mean that the subject item is not intentionally used or added in any amount, but may be present in very small amounts existing as impurities resulting from environmental or process conditions.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

We claim:

1. A foam composition comprising:
(a) from about 25 wt % to about 60 wt % of a propylene-based elastomer based on the foam composition, wherein the propylene-based polymer elastomer has an ethylene content of about 15 wt % to about 30 wt % based upon the weight of the propylene-based elastomer;
(b) a propylene polymer, comprising a homopolymer of propylene or a copolymer of propylene with from about 0.5 to about 4 wt % ethylene or C₄ to C₁₀ alpha-olefin comonomer derived units; and
(c) from about 0.5 to about 5 wt % of a foaming agent based on the foam composition, wherein the ratio of the propylene-based elastomer to the propylene polymer is about 40% to about 60%.

2. The composition of claim 1, wherein the propylene-based polymer elastomer has an ethylene content of about 16 wt % to about 18 wt % and a melt flow rate (2.16 kg weight at 230° C.) of greater than about 1 g/10 min to less than about 25 g/10 min.

3. The composition of claim 1, wherein the propylene-based elastomer is a reactor blend of a first polymer component and a second polymer component, wherein the first polymer component has an ethylene content R₁ of from greater than 5 to less than 30 wt % α-olefin, where the percentage by weight is based upon the total weight of the first polymer component, and wherein the second polymer component has an ethylene content R₂ of from greater than 1 to less than 10 wt % α-olefin, where the percentage by weight is based upon the total weight of the second polymer component.

4. The composition of claim 3, wherein the first polymer component has an α-olefin content R₁ of from 10 to 25 wt % α-olefin and the second polymer component has an α-olefin content R₂ of from greater than 2 to less than 8 wt % α-olefin.

5. The composition of claim 1, wherein the propylene polymer has a melt flow rate (2.16 kg weight at 230° C.) of greater than about 25 g/10 min to less than about 100 g/10 min.

6. The composition of claim 1, wherein the propylene polymer is a homopolymer of propylene.

7. The composition of claim 1, wherein the composition has a water absorption of less than about 5%.

8. A roofing membrane comprising the composition of claim 1.
